(19) United States
(12) Patent Application Publication
(10) Pub. No.: US 2019/0143696 A1
(43) Pub. Date: May 16, 2019

(54) HEAD CHIP, LIQUID JET HEAD AND LIQUID JET RECORDING DEVICE

(71) Applicant: SII Printek Inc., Chiba-shi (JP)

(72) Inventors: Yuki YAMAMURA, Chiba-shi (JP); Daichi NISHIKAWA, Chiba-shi (JP); Tomoki KAMEYAMA, Chiba-shi (JP); Misaki KOBAYASHI, Chiba-shi (JP)

(21) Appl. No.: 16/185,891

(22) Filed: Nov. 9, 2018

(30) Foreign Application Priority Data
Nov. 13, 2017 (JP) 2017-218096

(51) Int. Cl. B41J 2/165; B41J 2/14

(52) U.S. Cl. CPC B41J 2/16505; B41J 2/1433

(57) ABSTRACT

There are provided a head chip, a liquid jet head, and a liquid jet recording device capable of improving the ejection stability. The head chip according to an embodiment of the disclosure includes an actuator plate having a plurality of ejection grooves filled with liquid, and a plurality of non-ejection grooves not filled with the liquid, a nozzle plate having a plurality of nozzle holes individually communicated with the plurality of ejection grooves while not being communicated with the plurality of non-ejection grooves, a cover plate having a plurality of through holes adapted to respectively fill the plurality of ejection grooves with the liquid, and adapted to close the plurality of non-ejection grooves, and a communication mechanism adapted to communicate an outside of the head chip and the plurality of non-ejection grooves with each other via an opening part exposed to the outside of the head chip.

### RELATED APPLICATIONS

This application claims priority under 35 U.S.C. § 119 to Japanese Patent Application No. 2017-218096 filed on Nov. 13, 2017, the entire content of which is hereby incorporated by reference.

### BACKGROUND OF THE INVENTION

### 1. Field of the Invention

The present disclosure relates to a head chip, a liquid jet head and a liquid jet recording device.

### 2. Description of the Related Art

As one of liquid jet recording devices, there is provided an inkjet type recording device for ejecting (jetting) ink (liquid) on a recording target medium such as recording paper to perform recording of images, characters, and so on (see, e.g., JP-A-2012-51253).

In the liquid jet recording device of this type, it is arranged that the ink is supplied from an ink tank to an inkjet head (a liquid jet head), and then the ink is ejected from nozzle holes of the inkjet head toward the recording target medium to thereby perform recording of the images, the characters, and so on. Further, such an inkjet head is provided with a head chip for ejecting the ink.

In such a head chip or the like, in general, it is required to enhance the reliability. It is desirable to provide a head chip, a liquid jet head, and a liquid jet recording device capable of enhancing the reliability.

### SUMMARY OF THE INVENTION

A head chip according to an embodiment of the disclosure includes an actuator plate having a plurality of ejection grooves filled with the liquid, and a plurality of non-ejection grooves not filled with the liquid, a nozzle plate having a plurality of nozzle holes individually communicated with the plurality of ejection grooves while not being communicated with the plurality of non-ejection grooves, a cover plate having a plurality of through holes adapted to respectively fill the plurality of ejection grooves with the liquid, and adapted to close the plurality of non-ejection grooves, and a communication mechanism adapted to communicate an outside of the head chip and the plurality of non-ejection grooves with each other via an opening part exposed to the outside of the head chip.

A liquid jet head according to an embodiment of the disclosure is equipped with the head chip according to an embodiment of the disclosure.

A liquid jet recording device according to an embodiment of the disclosure is equipped with the liquid jet head according to an embodiment of the disclosure, and a containing section adapted to contain the liquid.

According to the head chip, the liquid jet head and the liquid jet recording device related to an embodiment of the disclosure, it becomes possible to enhance the reliability.

### BRIEF DESCRIPTION OF THE DRAWINGS

FIG. 1 is a schematic perspective view showing a schematic configuration example of a liquid jet recording device according to one embodiment of the disclosure.

FIG. 2 is a schematic diagram showing a cross-sectional configuration example of the liquid jet head shown in FIG. 1.

FIG. 3 is a schematic diagram showing a planar configuration example of a cover plate and so on in the head chip according to the embodiment.

FIG. 4 is a schematic enlarged view of the IV part shown in FIG. 3.

FIG. 5 is a schematic diagram showing a cross-sectional configuration example of the head chip along the line V-V shown in FIG. 4.

FIG. 6 is a schematic diagram showing a cross-sectional configuration example of the head chip along the line VI-VI shown in FIG. 4.

FIG. 7 is a schematic cross-sectional view showing a part of the communication mechanism and so on shown in FIG. 4 in an enlarged manner.

FIG. 8 is a schematic perspective view showing a part of the communication mechanism shown in FIG. 4 in an enlarged manner.

FIG. 9 is a schematic diagram showing an example of a vacuuming operation on a head chip related to a comparative example.

FIG. 10 is a schematic diagram showing an example of a vacuuming operation on the head chip according to the embodiment.

FIG. 11 is a schematic diagram showing another example of a vacuuming operation on the head chip according to the embodiment.

FIG. 12 is a schematic diagram showing a planar configuration example of a cover plate and so on in a head chip related to Modified Example 1.

FIG. 13 is a schematic diagram showing a planar configuration example of a cover plate and so on in a head chip related to Modified Example 2.

FIG. 14 is a schematic diagram showing a cross-sectional configuration example of a head chip related to Modified Example 3.

### DETAILED DESCRIPTION OF THE PREFERRED EMBODIMENTS

An embodiment of the present disclosure will hereinafter be described in detail with reference to the drawings. It should be noted that the description will be presented in the following order.

1. Embodiment (an example of a communication mechanism in which all of a plurality of non-ejection grooves is communicated with a single opening part)

### 2. Modified Examples

Modified Example 1 (first one of examples of a communication mechanism in which an opening part and a non-ejection groove are communicated with each other by a group).

Modified Example 2 (second one of the examples of the communication mechanism in which the opening part and the non-ejection groove are communicated with each other by the group).

Modified Example 3 (an example of a communication mechanism in which an opening part/a communication channel is formed inside an actuator plate).

### 3. Other Modified Examples

### 1. EMBODIMENT

### [Overall Configuration of Printer 1]

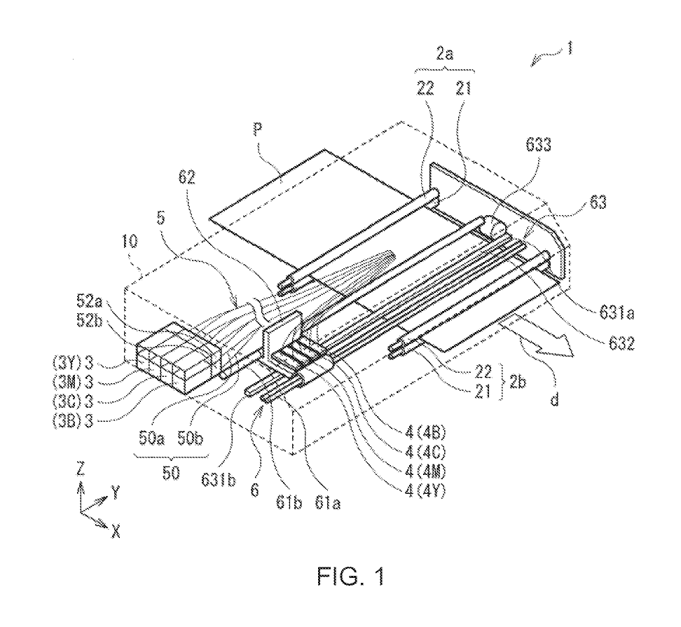

FIG. 1 is a perspective view schematically showing a schematic configuration example of a printer 1 as a liquid jet recording device according to one embodiment of the present disclosure. The printer 1 is an inkjet printer for performing recording (printing) of images, characters, and so on, on recording paper P as a recording target medium using ink 9 described later.

As shown in FIG. 1, the printer 1 is provided with a pair of carrying mechanisms 2a, 2b, ink tanks 3, inkjet heads 4, a circulation mechanism 5, and a scanning mechanism 6. These members are housed in a housing 10 having a predetermined shape. It should be noted that the scale size of each member is accordingly altered so that the member is shown large enough to recognize in the drawings used in the description of the specification.

Here, the printer 1 corresponds to a specific example of the “liquid jet recording device” in the present disclosure, and the inkjet heads 4 (the inkjet heads 4Y, 4M, 4C, and 4B described later) each correspond to a specific example of a “liquid jet head” in the present disclosure. Further, the ink 9 corresponds to a specific example of the “liquid” in the present disclosure.

The carrying mechanisms 2a, 2b are each a mechanism for carrying the recording paper P along the carrying direction d (an X-axis direction) as shown in FIG. 1. These carrying mechanisms 2a, 2b each have a grit roller 21, a pinch roller 22 and a drive mechanism (not shown). The grit roller 21 and the pinch roller 22 are each disposed so as to extend along a Y-axis direction (the width direction of the recording paper P). The drive mechanism is a mechanism for rotating (rotating in a Z-X plane) the grit roller 21 around an axis, and is constituted by, for example, a motor.

### (Ink Tanks 3)

The ink tanks 3 are each a tank for containing the ink 9 inside. As the ink tanks 3, there are disposed 4 types of tanks for individually containing 4 colors of ink 9, namely yellow (Y), magenta (M), cyan (C), and black (B), in this example as shown in FIG. 1. Specifically, there are disposed the ink tank 3Y for containing the yellow ink 9, the ink tank 3M for containing the magenta ink 9, the ink tank 3C for containing the cyan ink 9, and the ink tank 3B for containing the black ink 9. These ink tanks 3Y, 3M, 3C, and 3B are arranged side by side along the X-axis direction inside the housing 10.

It should be noted that the ink tanks 3Y, 3M, 3C, and 3B have the same configuration except the color of the ink 9 contained, and are therefore collectively referred to as ink tanks 3 in the following description. Further, the ink tanks 3 (3Y, 3M, 3C, and 3B) correspond to an example of a “containing section” in the present disclosure.

### (Inkjet Heads 4)

The inkjet heads 4 are each a head for jetting (ejecting) the ink 9 having a droplet shape from a plurality of nozzles (e.g., nozzle holes H1, H2) described later to the recording paper P to thereby perform recording of images, characters, and so on. As the inkjet heads 4, there are also disposed 4 types of heads for individually jetting the 4 colors of ink 9 respectively contained by the ink tanks 3Y, 3M, 3C, and 3B described above in this example as shown in FIG. 1. Specifically, there are disposed the inkjet head 4Y for jetting the yellow ink 9, the inkjet head 4M for jetting the magenta ink 9, the inkjet head 4C for jetting the cyan ink 9, and the inkjet head 4B for jetting the black ink 9. These inkjet heads 4Y, 4M, 4C, and 4B are arranged side by side along the Y-axis direction inside the housing 10.

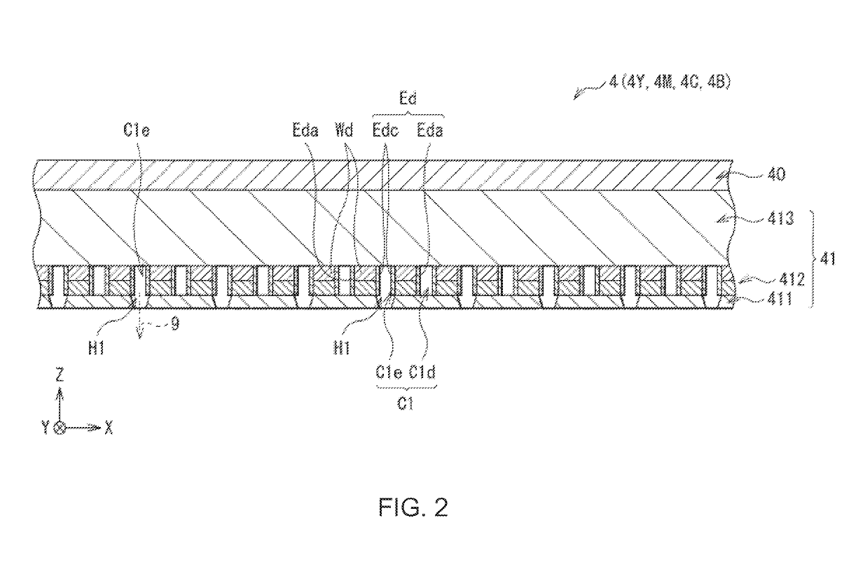

It should be noted that the inkjet heads 4Y, 4M, 4C, and 4B have the same configuration except the color of the ink 9 used, and are therefore collectively referred to as inkjet heads 4 in the following description. Further, the detailed configuration of the inkjet heads 4 will be described later (FIG. 2 through FIG. 6).

### (Circulation Mechanism 5)

The circulation mechanism 5 is a mechanism for circulating the ink 9 between the inside of the ink tanks 3 and the inside of the inkjet heads 4. The circulation mechanism 5 is configured including, for example, circulation channels 50 as flow channels for circulating the ink 9, and pairs of liquid feeding pumps 52a, 52b.

As shown in FIG. 1, the circulation channels 50 each have a flow channel 50a as a part extending from the ink tank 3 to reach the inkjet head 4 via the liquid feeding pump 52a, and a flow channel 50b as a part extending from the inkjet head 4 to reach the ink tank 3 via the liquid feeding pump 52b. In other words, the flow channel 50a is a flow channel through which the ink 9 flows from the ink tank 3 toward the inkjet head 4. Further, the flow channel 50b is a flow channel through which the ink 9 flows from the inkjet head 4 toward the ink tank 3. It should be noted that these flow channels 50a, 50b (supply tubes of the ink 9) are each formed of a flexible hose having flexibility.

### (Scanning Mechanism 6)

The scanning mechanism 6 is a mechanism for making the inkjet heads 4 perform a scanning operation along the width direction (the Y-axis direction) of the recording paper P. As shown in FIG. 1, the scanning mechanism 6 has a pair of guide rails 61a, 61b disposed so as to extend along the Y-axis direction, a carriage 62 movably supported by these guide rails 61a, 61b, and a drive mechanism 63 for moving the carriage 62 along the Y-axis direction. Further, the drive mechanism 63 is provided with a pair of pulleys 631a, 631b disposed between the pair of guide rails 61a, 61b, an endless belt 632 wound between the pair of pulleys 631a, 631b, and a drive motor 633 for rotationally driving the pulley 631a.

The pulleys 631a, 631b are respectively disposed in areas corresponding to the vicinities of both ends in each of the guide rails 61a, 61b along the Y-axis direction. To the endless belt 632, there is connected the carriage 62. On the carriage 62, there are disposed the four types of inkjet heads 4Y, 4M, 4C, and 4B arranged side by side along the Y-axis direction.

It should be noted that it is arranged that a moving mechanism for moving the inkjet heads 4 relatively to the recording paper P is constituted by such a scanning mechanism 6 and the carrying mechanisms 2a, 2b described above.

### [Detailed Configuration of Inkjet Heads 4]

Then, the detailed configuration example of the inkjet heads 4 (head chips 41) will be described with reference to FIG. 2 through FIG. 6, in addition to FIG. 1.

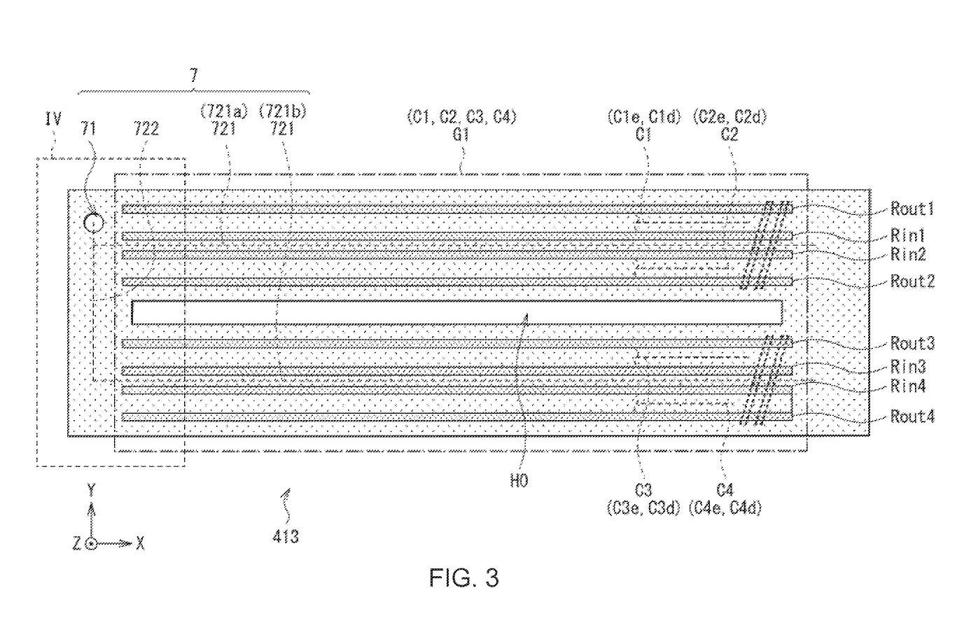

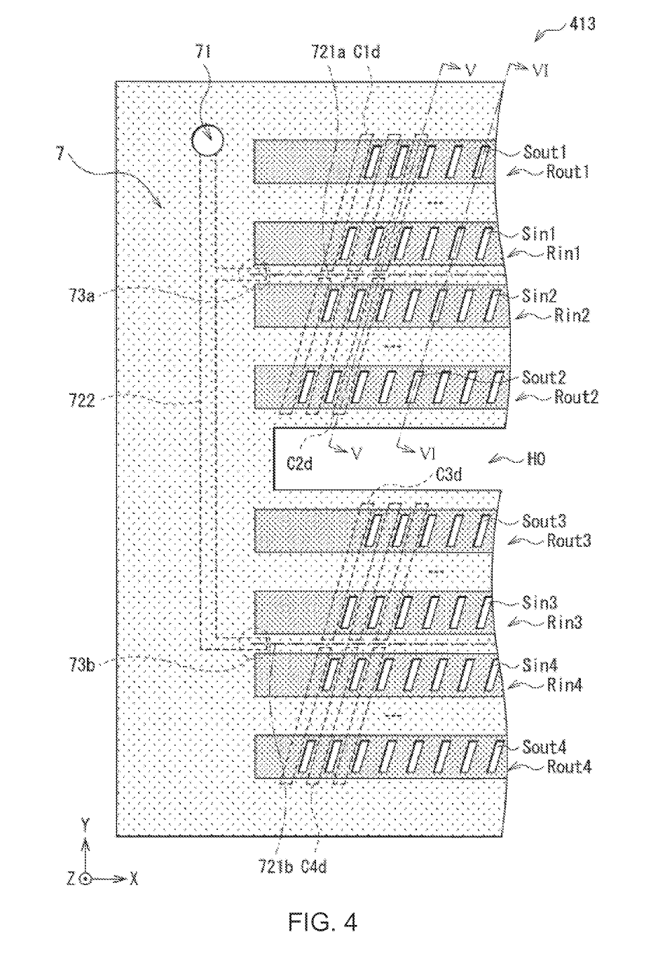

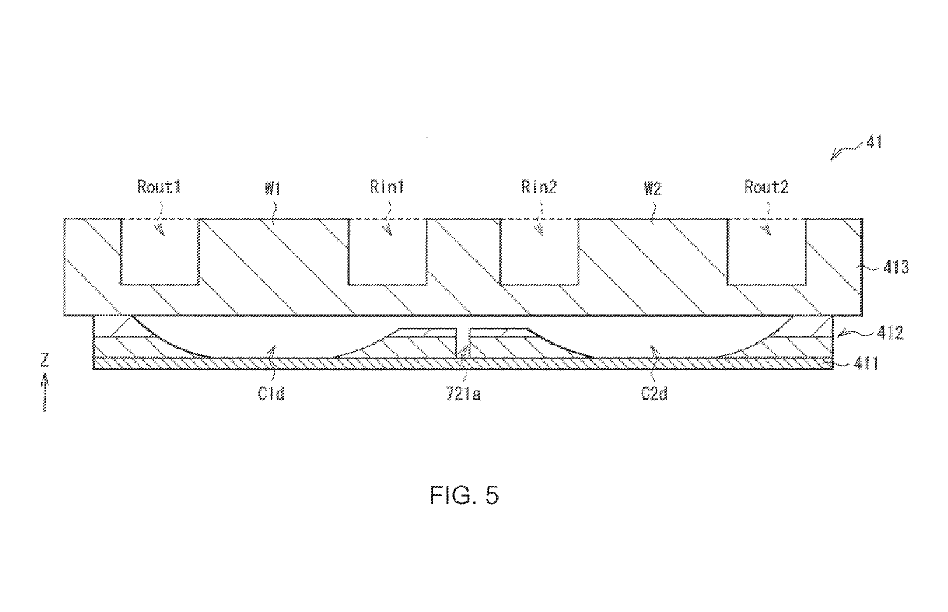

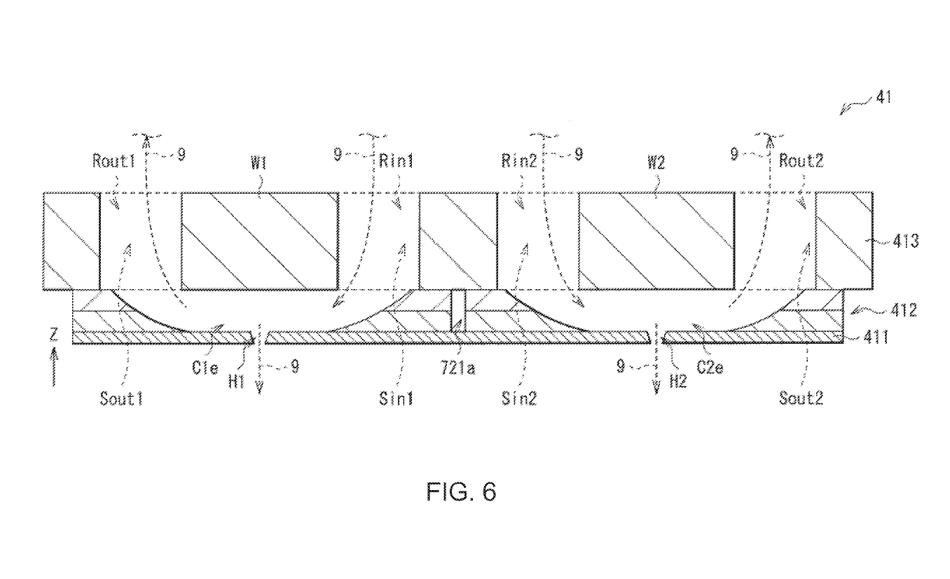

FIG. 2 is a diagram schematically showing a cross-sectional configuration example (a Z-X cross-sectional configuration example) of the inkjet head 4. FIG. 3 is a diagram schematically showing a planar configuration example (an X-Y planar configuration example) of a cover plate 413 (described later) and so on in the head chip 41 described later. FIG. 4 is a diagram schematically showing a part (the IV part in FIG. 4) of the planar configuration shown in FIG. 3 in an enlarged manner. FIG. 5 is a diagram schematically showing a cross-sectional configuration example (a Y-Z cross-sectional configuration example) of the head chip 41 along the line V-V shown in FIG. 4, and corresponds to a cross-sectional configuration example of the vicinity of dummy channels C1d, C2d (non-ejection grooves) in the head chip 41 described later. FIG. 6 is a diagram schematically showing a cross-sectional configuration example (a Y-Z cross-sectional configuration example) of the head chip 41 along the line VI-VI shown in FIG. 4, and corresponds to a cross-sectional configuration example of the vicinity of ejection channels C1e, C2e (ejection grooves) in the head chip 41 described later.

The inkjet heads 4 according to the present embodiment are each an inkjet head of a so-called side-shoot type for ejecting the ink 9 from a central part in an extending direction (an oblique direction described later) of a plurality of channels (channels C1, C2, C3, and C4) in the head chip 41 described later. Further, the inkjet heads 4 are each an inkjet head of a circulation type which uses the circulation mechanism 5 (the circulation channel 50) described above to thereby use the ink 9 while circulated between the inkjet head 4 and the ink tank 3.

As shown in FIG. 2, the inkjet heads 4 are each provided with the head chip 41 and a flow channel plate 40. Further, the inkjet heads 4 are each provided with a circuit board and flexible printed circuit board (FPC) as a control mechanism (a mechanism for controlling the operation of the head chip 41) not shown.

The circuit board is a board for mounting a drive circuit (an electric circuit) for driving the head chip 41. The flexible printed circuit board is a board for electrically connecting the drive circuit on the circuit board and drive electrodes Ed described later in the head chip 41 to each other. It should be noted that it is arranged that such flexible printed circuit board is provided with a plurality of extraction electrodes described later as printed wiring.

As shown in FIG. 2, the head chip 41 is a member for jetting the ink 9 along the Z-axis direction, and is configured using a variety of types of plates. Specifically, as shown in FIG. 2, the head chip 41 is mainly provided with a nozzle plate (a jet hole plate) 411, an actuator plate 412 and a cover plate 413. The nozzle plate 411, the actuator plate 412, the cover plate 413, and the flow channel plate 40 described above are bonded to each other using, for example, an adhesive, and are stacked on one another in this order along the Z-axis direction. It should be noted that the description will hereinafter be presented with the flow channel plate 40 side (the cover plate 413 side) along the Z-axis direction referred to as an upper side, and the nozzle plate 411 side referred to as a lower side.

### (Nozzle Plate 411)

The nozzle plate 411 is formed of a film member made of polyimide or the like having a thickness of, for example, about 50 μm, and is bonded to a lower surface of the actuator plate 412 as shown in FIG. 2. It should be noted that the constituent material of the nozzle plate 411 is not limited to the resin material such as polyimide, but can also be, for example, a metal material. Further, the nozzle plate 411 is provided with 4 nozzle columns each extending along the X-axis direction. These 4 nozzle columns are arranged along the Y-axis direction at predetermined intervals. As described above, the inkjet head 4 (the head chip 41) of the present embodiment is formed as a four-column type inkjet head (head chip).

The first nozzle column has a plurality of nozzle holes H1 formed in alignment with each other at predetermined intervals along the X-axis direction (see FIG. 2 and FIG. 6). These nozzle holes H1 each penetrate the nozzle plate 411 along the thickness direction of the nozzle plate 411 (the Z-axis direction), and are individually communicated with the respective ejection channels C1e in the actuator plate 412 described later as shown in, for example, FIG. 2 and FIG. 6.

Specifically, each of the nozzle holes H1 is formed so as to be located in a central part along the extending direction (the oblique direction described later) of the ejection channels C1e. Further, the formation pitch along the X-axis direction in the nozzle holes H1 is arranged to be equal (to have an equal pitch) to the formation pitch along the X-axis direction in the ejection channels C1e. Although the details will be described later, it is arranged that the ink 9 supplied from the inside of the ejection channel C1e is ejected (jetted) from such a nozzle hole H1.

The second nozzle column similarly has a plurality of nozzle holes H2 formed in alignment with each other at predetermined intervals along the X-axis direction (see FIG. 6). These nozzle holes H2 each penetrate the nozzle plate 411 along the thickness direction of the nozzle plate 411, and are individually communicated with the respective ejection channels C2e in the actuator plate 412 described later. Specifically, as shown in FIG. 6, each of the nozzle holes H2 is formed so as to be located in a central part along the extending direction (an oblique direction described later) of the ejection channels C2e. Further, the formation pitch along the X-axis direction in the nozzle holes H2 is arranged to be equal to the formation pitch along the X-axis direction in the ejection channels C2e. Although the details will be described later, it is arranged that the ink 9 supplied from the inside of the ejection channel C1e is also ejected from such a nozzle hole H2.

Further, the third and fourth nozzle columns each have also a plurality of nozzle holes (not shown) formed in alignment with each other at predetermined intervals along the X-axis direction in a similar manner. These nozzle holes each penetrate the nozzle plate 411 along the thickness direction of the nozzle plate 411, and are individually communicated with the respective ejection channels C3e or the respective ejection channels C4e in the actuator plate 412 described later. Specifically, each of the nozzle holes in the third nozzle column is formed so as to be located in a central part along the extending direction (the oblique direction described later) of the ejection channels C3e, and each of the nozzle holes in the fourth nozzle column is formed so as to be located in a central part along the extending direction (the oblique direction described later) of the ejection channels C4e. Further, the formation pitch along the X-axis direction in the nozzle holes of the third nozzle column is made equal to the formation pitch along the X-axis direction in the ejection channel C3e, and the formation pitch along the X-axis direction in the nozzle holes of the fourth nozzle column is made equal to the formation pitch along the X-axis direction in the ejection channel C4e. It is arranged that the ink 9 supplied from the inside of each of the ejection channels C3e is also ejected from the corresponding nozzle hole in such a third nozzle column, and the ink 9 supplied from the inside of each of the ejection channels C4e is also ejected from the corresponding nozzle hole in such a fourth nozzle column.

It should be noted that the nozzle holes such as nozzle holes H1, H2 in such nozzle columns are each a tapered through hole gradually decreasing in diameter toward the lower side.

### (Actuator Plate 412)

The actuator plate 412 is a plate formed of a piezoelectric material such as lead zirconate titanate (PZT). As shown in FIG. 2, the actuator plate 412 is formed by stacking two piezoelectric substrates different in polarization direction from each other on one another along the thickness direction (the Z-axis direction) (a so-called chevron type). It should be noted that the configuration of the actuator plate 412 is not limited to the chevron type. Specifically, it is also possible to form the actuator plate 412 with, for example, a single (unique) piezoelectric substrate having the polarization direction set one direction along the thickness direction (the Z-axis direction) (a so-called cantilever type).

As shown in FIG. 3 and FIG. 4, the first channel column is provided with a plurality of channels C1 each extending along the Y-axis direction. As shown in FIG. 3 and FIG. 4, these channels C1 extend along the oblique direction forming a predetermined angle (an acute angle) with the Y-axis direction inside the actuator plate 412. Further, as shown in FIG. 3 and FIG. 4, these channels C1 are arranged side by side so as to be parallel to each other at predetermined intervals along the X-axis direction. Each of the channels C1 is partitioned with drive walls Wd formed of a piezoelectric body (the actuator plate 412), and forms a groove section having a recessed shape in a cross-sectional view (see FIG. 2).

As shown in FIG. 3 and FIG. 4, the second, third and fourth channel columns respectively have pluralities of channels C2, C3, and C4 each extending along the oblique direction described above in a similar manner. As shown in FIG. 3 and FIG. 4, these channels C2, C3 and C4 are each arranged side by side so as to be parallel to each other at predetermined intervals along the X-axis direction. Each of the channels C2, C3 and C4 is also partitioned with drive walls Wd described above, and forms a groove section having a recessed shape in a cross-sectional view.

Here, as shown in FIG. 2 through FIG. 6, in each of the channels C1, there exist an ejection channel C1e (an ejection groove) for ejecting the ink 9, and a dummy channel C1d (a non-ejection groove) not ejecting the ink 9. In other words, it is arranged that the ejection channels C1e are filled with the ink 9 on the one hand, but the dummy channels C1d are not filled with the ink 9 on the other hand. As shown in FIG. 2, in the first channel column, the ejection channels C1e and the dummy channels C1d are alternately arranged along the X-axis direction. Further, each of the ejection channels C1e is communicated with the nozzle hole H1 in the nozzle plate 411 on the one hand, but each of the dummy channels C1d is not communicated with the nozzle hole H1, and is covered with an upper surface of the cover plate 411 from below on the other hand (see FIG. 2, FIG. 5 and FIG. 6).

Similarly, as shown in FIG. 3 through FIG. 6, in each of the channels C2, there exist an ejection channel C2e (an ejection groove) for ejecting the ink 9, and a dummy channel C2d (a non-ejection groove) not ejecting the ink 9. In other words, it is arranged that the ejection channels C2e are filled with the ink 9 on the one hand, but the dummy channels C2d are not filled with the ink 9 on the other hand. Similarly to the first channel column, in the second channel column, the ejection channels C2e and the dummy channels C2d are also alternately arranged along the X-axis direction. Each of the ejection channels C2e is communicated with the nozzle hole H2 in the nozzle plate 411 on the one hand, but each of the dummy channels C2d is not communicated with the nozzle hole H2, and is covered with the upper surface of the cover plate 411 from below on the other hand (see FIG. 5 and FIG. 6).

Similarly, as shown in FIG. 3 through FIG. 4, in each of the channels C3, there exist an ejection channel C3e (an ejection groove) for ejecting the ink 9, and a dummy channel C3d (a non-ejection groove) not ejecting the ink 9, and in each of the channels C4, there exist an ejection channel C4e (an ejection groove) for ejecting the ink 9, and a dummy channel C4d (a non-ejection groove) not ejecting the ink 9. In other words, it is arranged that the ejection channels C3e, C4e are filled with the ink 9 on the one hand, but the dummy channels C3d, C4d are not filled with the ink 9 on the other hand. Similarly to the first and second channel columns, in the third channel column, the ejection channels C3e and the dummy channels C3d are also alternately arranged along the X-axis direction, and in the fourth channel column, the ejection channels C4e and the dummy channels C4d are also alternately arranged along the X-axis direction. Each of the ejection channels C3e, C4e is communicated with the nozzle hole in the nozzle plate 411 on the one hand, but each of the dummy channels C3d, C4d is not communicated with the nozzle hole, and is covered with the upper surface of the cover plate 411 from below on the other hand.

It should be noted that such ejection channels C1e, C2e, C3e and C4e each correspond to a specific example of the “ejection groove” in the present disclosure. Further, the dummy channels C1d, C2d, C3d and C4d each correspond to a specific example of the “non-ejection groove” in the present disclosure.

Further, as indicated by the line VI-VI in FIG. 4, and as shown in FIG. 6, the ejection channels C1e in the first channel column and the ejection channel C2e in the second channel column are disposed in alignment with each other along the extending direction (the oblique direction described above) of these ejection channels C1e, C2e. Similarly, as indicated by the line V-V in FIG. 4, and as shown in FIG. 5, the dummy channels C1d in the first channel column and the dummy channel C2d in the second channel column are disposed in alignment with each other along the extending direction (the oblique direction described above) of these dummy channels C1d, C2d.

Here, as shown in FIG. 2, the drive electrode Ed extending along the Y-axis direction is disposed on each of the inside surfaces opposed to each other in the drive walls Wd described above. As the drive electrodes Ed, there exist common electrodes Edc disposed on the inner side surfaces facing the ejection channels C1e, C2e, C3e and C4e and individual electrodes (active electrodes) Eda disposed on the inner side surfaces facing the dummy channels C1d, C2d, C3d and C4d. It should be noted that such drive electrodes Ed (the common electrodes Edc and the active electrodes Eda) are each formed in the entire area in the depth direction (the Z-axis direction) on the inner side surface of the drive wall Wd as shown in FIG. 2.

The pair of common electrodes Edc opposed to each other in the same ejection channel C1e, C2e, C3e or C4e are electrically connected to each other in a common terminal (a common interconnection) not shown. Further, the pair of individual electrodes Eda opposed to each other in the same dummy channel C1d, C2d, C3d or C4d are electrically separated from each other. In contrast, a pair of individual electrodes Eda opposed to each other via the ejection channel C1e, C2e, C3e or C4e are electrically connected to each other in an individual terminal (an individual interconnection) not shown.

Here, in both end parts (tail parts) along the Y-axis direction in the actuator plate 412, there are mounted the flexible printed circuit boards described above for electrically connecting the drive electrodes Ed and the circuit board described above to each other. Interconnection patterns (not shown) provided to the flexible printed circuit board are electrically connected to the common interconnections and the individual interconnections described above. Thus, it is arranged that a drive voltage is applied to each of the drive electrodes Ed from the drive circuit on the circuit board described above via the flexible printed circuit board.

### (Cover Plate 413)

As shown in FIG. 2 through FIG. 6, the cover plate 413 is disposed so as to close the channels C1, C2, C3 and C4 (the channel columns) in the actuator plate 412. Specifically, the cover plate 413 is bonded to the upper surface of the actuator plate 412, and has a plate-like structure. It should be noted that as shown in FIG. 3 and FIG. 4, a penetrating groove H0 formed in the vicinity of a central area in the cover plate 413 extends along the X-axis direction and at the same time penetrates the cover plate 413 along the Z-axis direction, and it is arranged that the flexible printed circuit board described above is inserted through the penetrating groove H0. Further, such a penetrating groove (not shown) for inserting the flexible printed circuit board is arranged to be provided also to the nozzle plate 411 and the actuator plate 412.

As shown in FIG. 3 through FIG. 6, the cover plate 413 is provided with entrance side common ink chambers Rin1, Rin2, Rin3 and Rin4 and exit side common ink chambers Rout1, Rout2, Rout3 and Rout4. The entrance side common ink chambers Rin1, Rin2, Rin3 and Rin4 and the exit side common ink chambers Rout1, Rout2, Rout3 and Rout4 each extend along the X-axis direction, and are arranged side by side so as to be parallel to each other at predetermined intervals. Further, the entrance side common ink chamber Rin1 and the exit side common ink chamber Rout1 are each formed in an area corresponding to the first channel column (the plurality of channels C1) in the actuator plate 412. Further, the entrance side common ink chamber Rin2 and the exit side common ink chamber Rout2 are each formed in an area corresponding to the second channel column (the plurality of channels C2) in the actuator plate 412. Similarly, the entrance side common ink chamber Rin3 and the exit side common ink chamber Rout3 are each formed in an area corresponding to the third channel column (the plurality of channels C3) in the actuator plate 412. The entrance side common ink chamber Rin4 and the exit side common ink chamber Rout4 are each formed in an area corresponding to the fourth channel column (the plurality of channels C4) in the actuator plate 412.

The entrance side common ink chamber Rin1 is formed in the vicinity of an inner end part along the Y-axis direction in the channels C1, and forms a groove section having a recessed shape (see FIG. 3 through FIG. 6). In areas corresponding respectively to the ejection channels C1e in the entrance side common ink chamber Rin1, there are respectively formed supply slits Sin1 penetrating the cover plate 413 along the thickness direction (the Z-axis direction) of the cover plate 413 (see FIG. 4 and FIG. 6). Similarly, the entrance side common ink chambers Rin2, Rin3 and Rin4 are respectively formed in the vicinities of inner end parts along the Y-axis direction in the respective channels C2, C3 and C4, and each form a groove section having a recessed shape (see FIG. 3 through FIG. 6). In areas corresponding respectively to the ejection channels C2e, C3e or C4e in the entrance side common ink chamber Rin2, Rin3 or Rin4, there are respectively formed supply slits Sin2, Sin3 or Sin4 penetrating the cover plate 413 along the thickness direction of the cover plate 413 (see FIG. 4 and FIG. 6).

It should be noted that the supply slits Sin1, Sin2, Sin3 or Sin4 are each a through hole for making the ink 9 inflow into the ejection channel C1e, C2e, C3e or C4e, and each correspond to a specific example of a “through hole” in the present disclosure.

The exit side common ink chamber Rout1 is formed in the vicinity of an outer end part along the Y-axis direction in the channels C1, and forms a groove section having a recessed shape (see FIG. 3 through FIG. 6). In areas corresponding respectively to the ejection channels C1e in the exit side common ink chamber Rout1, there are respectively formed discharge slits Sout1 penetrating the cover plate 413 along the thickness direction of the cover plate 413 (see FIG. 4 and FIG. 6). Similarly, the exit side common ink chambers Rout2, Rout3 and Rout4 are respectively formed in the vicinities of outer end parts along the Y-axis direction in the respective channels C2, C3 and C4, and each form a groove section having a recessed shape (see FIG. 3 through FIG. 6). In areas corresponding respectively to the ejection channels C2e, C3e or C4e in the exit side common ink chamber Rout2, Rout3 or Rout4, there are respectively formed discharge slits Sin2, Sin3 or Sin4 penetrating the cover plate 413 along the thickness direction of the cover plate 413 (see FIG. 4 and FIG. 6).

It should be noted that the discharge slits Sout1, Sout2, Sout3 or Sout4 are each a through hole for making the ink 9 outflow from the ejection channel C1e, C2e, C3e or C4e, and each correspond to a specific example of a “through hole” in the present disclosure.

In such a manner, the entrance side common ink chamber Rin1 and the exit side common ink chamber Rout1 are communicated with each of the ejection channels C1e via the supply slit Sin1 and the discharge slit Sout1 on the one hand, but are not communicated with each of the dummy channels C1d on the other hand (see FIG. 5 and FIG. 6). In other words, it is arranged that each of the dummy channels C1d is closed by a bottom part of the entrance side common ink chamber Rin1 and a bottom part of the exit side common ink chamber Rout1 (see FIG. 5).

Similarly, the entrance side common ink chamber Rin2 and the exit side common ink chamber Rout2 are communicated with each of the ejection channels C2e via the supply slit Sin2 and the discharge slit Sout2 on the one hand, but are not communicated with each of the dummy channels C2d on the other hand (see FIG. 5 and FIG. 6). In other words, it is arranged that each of the dummy channels C2d is closed by a bottom part of the entrance side common ink chamber Rin2 and a bottom part of the exit side common ink chamber Rout2 (see FIG. 5).

Similarly, the entrance side common ink chamber Rin3 and the exit side common ink chamber Rout3 are communicated with each of the ejection channels C3e via the supply slit Sin3 and the discharge slit Sout3 on the one hand, but are not communicated with each of the dummy channels C3d on the other hand. In other words, it is arranged that each of the dummy channels C3d is closed by a bottom part of the entrance side common ink chamber Rin3 and a bottom part of the exit side common ink chamber Rout3. Further, the entrance side common ink chamber Rin4 and the exit side common ink chamber Rout4 are communicated with each of the ejection channels C4e via the supply slit Sin4 and the discharge slit Sout4 on the one hand, but are not communicated with each of the dummy channels C4d on the other hand. In other words, it is arranged that each of the dummy channels C4d is closed by a bottom part of the entrance side common ink chamber Rin4 and a bottom part of the exit side common ink chamber Rout4.

Further, as shown in FIG. 5 and FIG. 6, the cover plate 413 is provided with wall parts such as wall parts W1, W2. The wall part W1 is disposed so as to cover above the ejection channel C1e, and the wall part W2 described above is disposed so as to cover above the ejection channel C2e. Similarly, it is arranged that the wall part (not shown) also covers above the ejection channels C3e, C4e. Further, as shown in FIG. 6, these ejection channels C1e, C2e, C3e and C4e each have arc-like side surfaces with which the cross-sectional area of each of the ejection channels C1e, C2e, Ce3 and Ce4 gradually decreases in a direction from the cover plate 413 side (upper side) toward the nozzle plate 411 side (lower side). It should be noted that it is arranged that the arc-like side surfaces of such ejection channels C1e, C2e, C3e and C4e are each formed by, for example, cutting work using a dicer.

### (Flow Channel Plate 40)

As shown in FIG. 2, the flow channel plate 40 is disposed on the upper surface of the cover plate 413, and has a predetermined flow channel (not shown) through which the ink 9 flows. Further, to the flow channel in such a flow channel plate 40, there are connected the flow channels 50a, 50b in the circulation mechanism 5 described above so as to achieve inflow of the ink 9 to the flow channel and outflow of the ink 9 from the flow channel, respectively.

### [Configuration of Communication Mechanism 7]

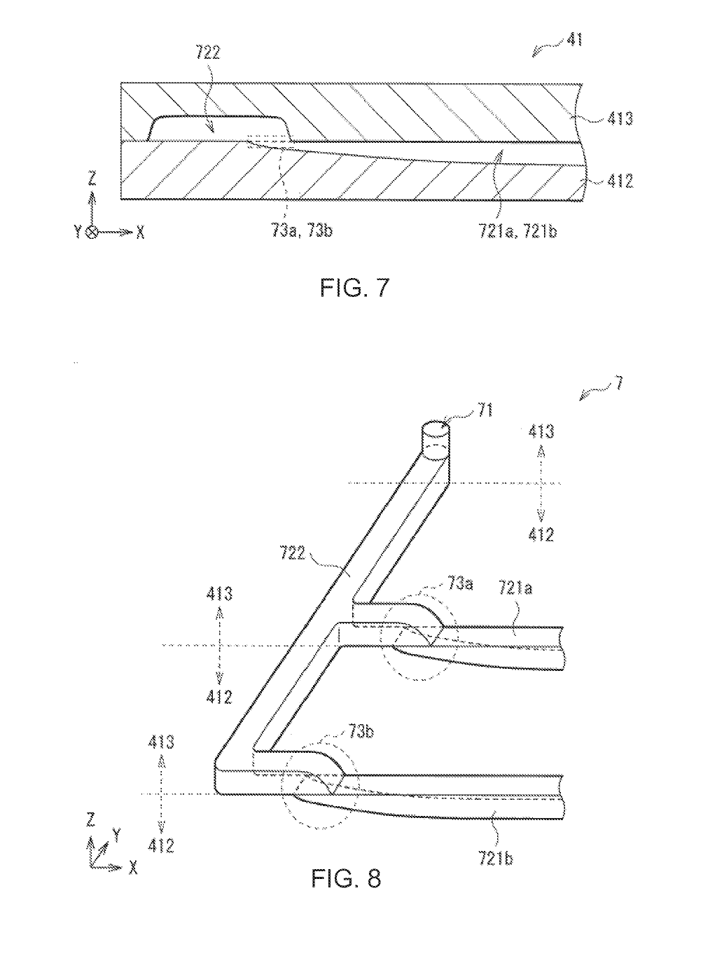

Then, with reference to FIG. 7 and FIG. 8 in addition to FIG. 3 through FIG. 6 described above, a communication mechanism 7 for communicating the outside of the head chip 41 and the dummy channels C1d, C2d, C3d and C4d (non-ejection grooves) with each other will be described in detail.

FIG. 7 is a schematic cross-sectional view (a cross-sectional view in the Z-X plane) showing a part of the communication mechanism 7 and so on shown in FIG. 4 in an enlarged manner. Further, FIG. 8 is a schematic cross-sectional view showing a part of the communication mechanism 7 shown in FIG. 4 in an enlarged manner.

As shown in FIG. 3 through FIG. 8, the head chip 41 according to the present embodiment is provided with the communication mechanism 7 for communicating the outside of the head chip 41 and the plurality of dummy channels (the non-ejection grooves) C1d, C2d, C3d and C4d with each other via the opening part 71 exposed to the outside of the head chip 41. Specifically, the communication mechanism 7 has the opening part 71 described above, and communication channels (communication channels 721, 722 described later) for communicating the opening part 71 and the dummy channels C1d, C2d, C3d and C4d with each other. It should be noted that in other words, in the head chip 41, there is adopted a structure in which any of the dummy channels C1d, C2d, C3d and C4d is not communicated with the outside of the head chip 41 except the opening part 71 in such a communication mechanism 7.

As shown in FIG. 3 through FIG. 8, the communication mechanism 7 is formed in both of the actuator plate 412 and the cover plate 413. Specifically, in the communication mechanism 7, the opening part 71 described above is provided to the cover plate 413 (see FIG. 3, FIG. 4, FIG. 7 and FIG. 8). Further, the communication channels described above are formed in both of the actuator plate 412 and the cover plate 413. In other words, as the communication channels, there are disposed the communication channels 721 provided to the actuator plate 412 and communicated with the dummy channels C1d, C2d, C3d and C4d, and the communication channel 722 provided to the cover plate 413 and communicating the opening part 71 and the communication channels 721 with each other (see FIG. 3, FIG. 4, FIG. 7 and FIG. 8). Further, in the present embodiment, as the communication channels 721, there are provided a communication channel 721a to be communicated with the dummy channels C1d, C2d, and a communication channel 721b to be communicated with the dummy channels C3d, C4d. It should be noted that as shown in FIG. 4 and FIG. 8, such communication channels 721a, 721b and the communication channel 722 are arranged to be communicated with (connected to) each other in communication parts 73a, 73b, respectively.

Here, as shown in FIG. 3 and FIG. 4, in the communication mechanism 7 of the present embodiment, there is provided just one opening part 71. Further, unlike the modified example described later, all of the non-ejection grooves (the dummy channels C1d, C2d, C3d and C4d) in the head chip 41 belong to a single group (a group G1) (see FIG. 3). Further, the communication channels (the communication channels 721, 722) in the communication mechanism 7 are arranged to communicate all of the non-ejection grooves in such a head chip 41 with the single opening part 71 (see FIG. 3 and FIG. 4).

Further, as shown in FIG. 3 and FIG. 4, in the communication mechanism 7 of the present embodiment, the opening part 71 is formed in an end part area (a non-formation area of the channels C1, C2, C3 and C4 along the longitudinal direction) along the longitudinal direction (the X-axis direction) in the head chip 41. Further, the communication channels 721 (721a, 721b) provided to the actuator plate 412 extend along the X-axis direction which is the longitudinal direction of the head chip 41, and at the same time the arrangement direction of the dummy channels C1d, C2d, C3d and C4d (see FIG. 3 through FIG. 8). In contrast, the communication channel 722 provided to the cover plate 413 basically extends along the short-side direction (the Y-axis direction) of the head chip 41 except the areas in the vicinity of the respective communication parts 73a, 73b described above (see FIG. 3, FIG. 4, FIG. 7 and FIG. 8).

It should be noted that such a communication mechanism 7 (the opening part 71) is arranged to ultimately be closed from above with the flow channel plate 40 in the manufacturing process of the inkjet 4 (the head chip 41) (see FIG. 2). Further, it is arranged that a checking operation of a leakage state Led described later is performed by using the communication mechanism 7 in an inspection process as an anterior stage of attaching the flow channel plate 40 on the cover plate 413. In such a manner as described above, since the opening part 71 of the communication mechanism 7 is closed after the inkjet head 4 is manufactured, the possibility that the ink 9 enters the dummy channels C1d, C2d, C3d and C4d from the opening part 71 is prevented.

Here, the communication channels 721 (721a, 721b) each correspond to a specific example of a “first communication channel” in the present disclosure, and the communication channel 722 corresponds to a specific example of a “second communication channel” in the present disclosure. Further, the X-axis direction corresponds to a specific example of an “arrangement direction” and a “longitudinal direction” in the present disclosure.

### [Operations and Functions/Advantages]

### (A. Basic Operation of Printer 1)

In the printer 1, a recording operation (a printing operation) of images, characters, and so on to the recording paper P is performed in the following manner. It should be noted that as an initial state, it is assumed that the four types of ink tanks 3 (3Y, 3M, 3C, and 3B) shown in FIG. 1 are sufficiently filled with the ink 9 of the corresponding colors (the four colors), respectively. Further, there is achieved the state in which the inkjet heads 4 are filled with the ink 9 in the ink tanks 3 via the circulation mechanism 5, respectively.

In such an initial state, when operating the printer 1, the grit rollers 21 in the carrying mechanisms 2a, 2b rotate to thereby carry the recording paper P along the carrying direction d (the X-axis direction) between the grit rollers 21 and the pinch rollers 22. Further, at the same time as such a carrying operation, the drive motor 633 in the drive mechanism 63 respectively rotates the pulleys 631a, 631b to thereby operate the endless belt 632. Thus, the carriage 62 reciprocates along the width direction (the Y-axis direction) of the recording paper P while being guided by the guide rails 61a, 61b. Then, on this occasion, the four colors of ink 9 are appropriately ejected on the recording paper P by the respective inkjet heads 4 (4Y, 4M, 4C, and 4B) to thereby perform the recording operation of images, characters, and so on to the recording paper P.

### (B. Detailed Operation in Inkjet Heads 4)

Then, the detailed operation (the jet operation of the ink 9) in the inkjet heads 4 will be described with reference to FIG. 1 through FIG. 6. Specifically, in the inkjet heads 4 (the side-shoot type) according to the present embodiment, the jet operation of the ink 9 using a shear mode is performed in the following manner.

Firstly, when the reciprocation of the carriage 62 (see FIG. 1) described above is started, the drive circuit on the circuit board described above applies the drive voltage to the drive electrodes Ed (the common electrodes Edc and the individual electrodes Eda) in the inkjet head 4 via the flexible printed circuit boards described above. Specifically, the drive circuit applies the drive voltage to the drive electrodes Ed disposed on the pair of drive walls Wd forming the ejection channel C1e, C2e, C3e, C4e. Thus, the pair of drive walls Wd each deform (see FIG. 2) so as to protrude toward the dummy channel C1d, C2d, C3d, C4d adjacent to the ejection channel C1e, C2e, C3e, C4e.

Here, as described above, in the actuator plate 412, the polarization direction differs along the thickness direction (the two piezoelectric substrates described above are stacked on one another), and at the same time, the drive electrodes Ed are formed in the entire area in the depth direction on the inner side surface in each of the drive walls Wd. Therefore, by applying the drive voltage using the drive circuit described above, it results that the drive wall Wd makes a flexion deformation to have a V shape centered on the intermediate position in the depth direction in the drive wall Wd. Further, due to such a flexion deformation of the drive wall Wd, the ejection channel C1e, C2e, C3e, C4e deforms as if the ejection channel C1e, C2e, C3e, C4e bulges. Incidentally, in the case in which the configuration of the actuator plate 412 is not the chevron type but is the cantilever type described above, the drive wall Wd makes the flexion deformation to have the V shape in the following manner. That is, in the case of the cantilever type, since it results that the drive electrode Ed is attached by the oblique evaporation to an upper half in the depth direction, by the drive force exerted only on the part provided with the drive electrode Ed, the drive wall Wd makes the flexion deformation (in the end part in the depth direction of the drive electrode Ed). As a result, even in this case, since the drive wall Wd makes the flexion deformation to have the V shape, it results that the ejection channel C1e, C2e, C3e, C4e deforms as if the ejection channel C1e, C2e, C3e, C4e bulges.

As described above, due to the flexion deformation caused by a piezoelectric thickness-shear effect in the pair of drive walls Wd, the capacity of the ejection channel C1e, C2e, C3e, C4e increases. Further, due to the increase of the capacity of the ejection channel C1e, C2e, C3e, C4e, it results that the ink 9 retained in the entrance side common ink chamber Rin1, Rin2, Rin3, Rin4 is induced into the ejection channel C1e, C2e, C3e, C4e (see FIG. 6).

Subsequently, the ink 9 having been induced into the ejection channel C1e, C2e, C3e, C4e in such a manner turns to a pressure wave to propagate to the inside of the ejection channel C1e, C2e, C3e, C4e. Then, the drive voltage to be applied to the drive electrodes Ed becomes 0 (zero) V at the timing at which the pressure wave has reached the nozzle hole such as nozzle hole H1, H2 of the nozzle plate 411. Thus, the drive walls Wd are restored from the state of the flexion deformation described above, and as a result, the capacity of the ejection channel C1e, C2e, C3e, C4e having once increased is restored again (see FIG. 2).

When the capacity of the ejection channel C1e, C2e, C3e, C4e is restored in such a manner, the internal pressure of the ejection channel C1e, C2e, C3e, C4e increases, and the ink 9 in the ejection channel C1e, C2e, C3e, C4e is pressurized. As a result, the ink 9 having a droplet shape is ejected (see FIG. 2 and FIG. 6) toward the outside (toward the recording paper P) through the nozzle hole such as the nozzle hole H1, H2. The jet operation (the ejection operation) of the ink 9 in the inkjet head 4 is performed in such a manner, and as a result, the recording operation of images, characters, and so on to the recording paper P is performed.

In particular, the nozzle holes (e.g., the nozzle holes H1, H2) of the present embodiment each have the tapered cross-sectional shape gradually decreasing in diameter toward the outlet (see FIG. 2 and FIG. 6) as described above, and can therefore eject the ink 9 straight (good in straightness) at high speed. Therefore, it becomes possible to perform recording high in image quality.

### (C. Circulation Operation of Ink 9)

Then, the circulation operation of the ink 9 by the circulation mechanism 5 will be described in detail with reference to FIG. 1 and FIG. 6.

As shown in FIG. 1, in the printer 1, the ink 9 is fed by the liquid feeding pump 52a from the inside of the ink tank 3 to the inside of the flow channel 50a. Further, the ink 9 flowing through the flow channel 50b is fed by the liquid feeding pump 52b to the inside of the ink tanks 3.

On this occasion, in the inkjet head 4, the ink 9 flowing from the inside of the ink tank 3 via the flow channel 50a passes through the flow channel of the flow channel plate 40 to inflow into the entrance side common ink chamber Rin1, Rin2, Rin3, Rin4. As shown in FIG. 6, the ink 9 having been supplied to these entrance side common ink chambers Rin1, Rin2, Rin3, Rin4 is supplied to the ejection channels C1e, C2e, C3e, C4e in the actuator plate 412 via the supply slits Sin1, Sin2, Sin3, Sin4.

Further, as shown in FIG. 6, the ink 9 in the ejection channels C1e, C2e, C3e, C4e flows into the exit side common ink chamber Rout1, Rout2, Rout3, Rout4 via the discharge slits Sout1, Sout2, Sout3, Sout4, respectively. The ink 9 having been supplied to these exit side common ink chambers Rout1, Rout2, Rout3, Rout4 is discharged to the flow channel 50b via the flow channel of the flow channel plate 40 to thereby outflow from the inkjet head 4 (see FIG. 2). Then, the ink 9 having been discharged to the flow channel 50b is returned to the inside of the ink tank 3 as a result. In such a manner, the circulation operation of the ink 9 by the circulation mechanism 5 is achieved.

Here, in the inkjet head which is not the circulation type, in the case in which ink of a fast drying type is used, there is a possibility that a local increase in viscosity or local solidification of the ink occurs due to drying of the ink in the vicinity of the nozzle hole, and as a result, a failure such as an ink ejection failure occurs. In contrast, in the inkjet heads 4 (the circulation type inkjet heads) according to the present embodiment, since the fresh ink 9 is always supplied to the vicinities of the nozzle holes (e.g., the nozzle holes H1, H2), the failure such as the ink ejection failure described above is prevented as a result.

### (D. Functions/Advantages)

Then, the functions and the advantages in the head chip 41, the inkjet head 4 and the printer 1 according to the present embodiment will be described in detail while comparing with a comparative example.

### Comparative Example

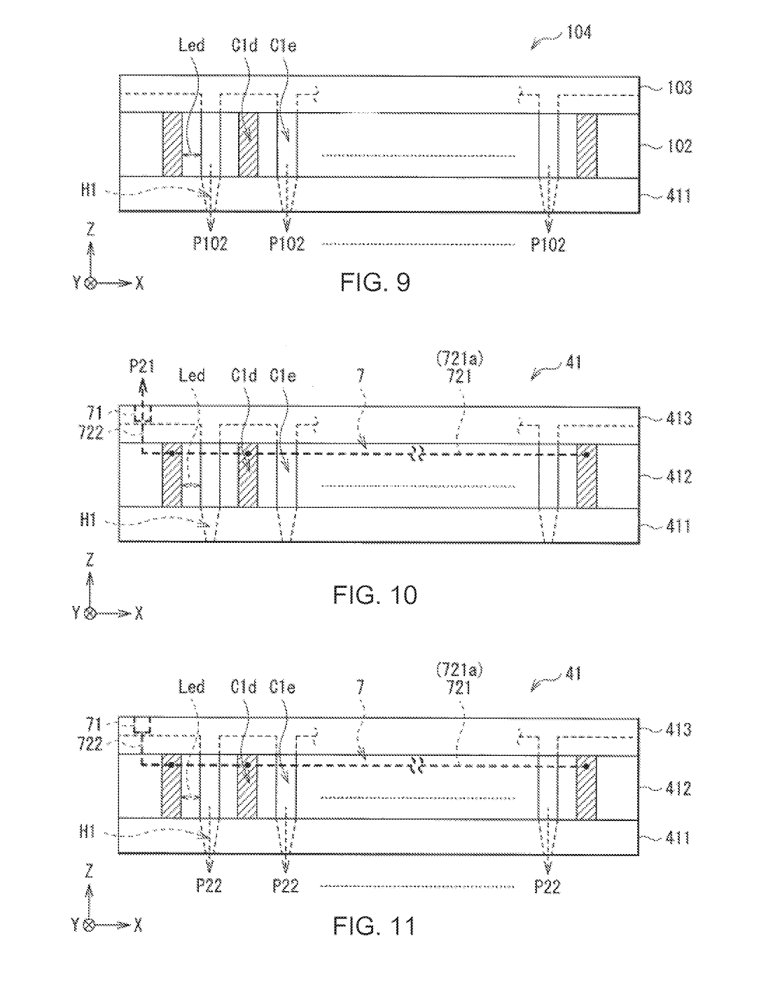

FIG. 9 is a side view (a Z-X side view) schematically showing an example of a vacuuming operation on a head chip (a head chip 104) related to a comparative example. The head chip 104 of the comparative example corresponds to what is not provided with the communication mechanism 7 in the head chip 41 according to the present embodiment. Specifically, the head chip 104 corresponds to what is provided with an actuator plate 102 and a cover plate 103 not provided with the communication mechanism 7 instead of the actuator plate 412 and the cover plate 413 provided with the communication mechanism 7 in the head chip 41.

In the head chip 104 of this comparative example, it is not achievable to perform detection (leakage detection) of presence or absence of the leakage state Led (an unintended communication state between the ejection channel (the ejection groove) such as the ejection channel C1e and the dummy channel (the non-ejection groove) such as the dummy channel C1d) between the ejection groove and the non-ejection groove. This is because in the head chip 104 of the comparative example not provided with the communication mechanism 7, there is adopted a structure in which any of the dummy channels C1d, C2d, C3d and C4d is not communicated with the outside of the head chip 104. Specifically, in the case in which vacuuming on the head chip 104 is performed via the nozzle holes such as the nozzle holes H1 and the ejection channels such as the ejection channels C1e as indicated by, for example, the arrow P102 in FIG. 9, the following is brought about even if the leakage state Led described above has occurred. That is, in this case, since the dummy channels C1d, C2d, C3d, C4d are not communicated with the outside of the head chip 104, even if the leakage state Led occurs between the dummy channels C1d, C2d, C3d, C4d and the ejection channels C1e, C2e, C3e, C4e, the vacuum pressure (degree of vacuum) hardly changes.

Incidentally, such a leakage state Led generally occurs due to, for example, the causes listed as (a) through (d) below. Further, if the leakage state Led occurs, the ink 9 enters, for example, the dummy channels C1d, C2d, C3d, C4d, and there is a possibility that the individual electrodes Eda opposed to each other are shorted to each other, and the individual electrode Eda gets corroded. Therefore, in the comparative example not capable of performing the detection (the leakage detection) of presence or absence of such a leakage state Led, the reliability of the head chip 104 is damaged as a result.

(a) a gap generated in the boundary between the actuator plate and the cover plate (adhesion failure)

(b) a gap generated in the boundary between the two piezoelectric substrates constituting the actuator plate in the case in which the actuator plate is the chevron type described above (adhesion failure)

(c) a hole generated in the actuator plate (a defect of the piezoelectric material such as PZT constituting the actuator plate)

(d) a crack or a broken pillar generated in the drive wall of the actuator plate

### Present Embodiment

In contrast, in the head chip 41 according to the present embodiment, there is provided the communication mechanism 7 for communicating the outside of the head chip 41 and the plurality of dummy channels (the non-ejection grooves) C1d, C2d, C3d and C4d with each other via the opening part 71 exposed to the outside of the head chip 41 as shown in FIG. 3 through FIG. 8.

Thus, in the head chip 41, unlike the head chip 104 of the comparative example described above, by performing vacuuming from the outside via the communication mechanism 7, for example, it becomes possible to detect presence or absence of such a leakage state Led as described above (it becomes possible to perform such leakage detection).

Here, FIG. 10 and FIG. 11 are each a side view (a Z-X side view) schematically showing an operation example of vacuuming on a head chip 41 according to the present embodiment.

Firstly, in the case of performing vacuuming on the head chip 41 via the communication mechanism 7 (the opening part 71 and the communication channels 721, 722) as indicated by, for example, the arrow P21 in FIG. 10, presence or absence of the leakage state Led is detected in the following manner. Specifically, firstly, in the case in which the leakage state Led does not exist, since the dummy channels C1d, C2d, C3d, C4d are not communicated with the outside of the head chip 41 except the opening part 71, vacuuming can be achieved. In contrast, in the case in which the leakage state Led exists, since the external air can be taken in from the ejection channels C1e, C2e, C3e, C4e communicated with the outside of the head chip 41, vacuuming cannot be achieved. Further, by checking whether or not such a vacuum state can be kept for a predetermined period of time, it becomes possible to detect presence or absence of the leakage state Led in the head chip 41.

Further, it is also possible to arrange that vacuuming on the head chip 41 is performed via the nozzle holes such as the nozzle holes H1 and the ejection channels C1e, C2e, C3e, C4e as indicated by the arrow P22 in FIG. 11, for example. In this case, unlike the head chip 104 of the comparative example described above, since the dummy channels C1d, C2d, C3d, C4d and the outside of the head chip 41 are communicated with each other via the communication mechanism 7, presence or absence of the leakage state Led is detected in the following manner. Specifically, in the case in which the leakage state Led exists, since the external air can be taken in from the dummy channels C1d, C2d, C3d, C4d communicated with the outside of the head chip 41 via the communication mechanism 7, vacuuming cannot be achieved. In contrast, in the case in which the leakage state Led does not exist, vacuuming can be achieved. Therefore, also in this case, by checking whether or not such a vacuum state can be kept for a predetermined period of time, it becomes possible to detect presence or absence of the leakage state Led in the head chip 41.

Since in the embodiment described above, it is arranged to provide the communication mechanism 7 to the head chip 41 in such a manner as described above, it is possible to detect presence or absence of the leakage state Led between the ejection channels C1e, C2e, C3e, C4e and the dummy channels C1d, C2d, C3d, C4d. Therefore, it becomes possible to enhance the reliability of the head chip 41 compared to the head chip 104 of the comparative example described above. Further, as such leakage inspection, it is possible to cite the example (the example of the leakage inspection via the communication mechanism 7) shown in FIG. 10 and the example (the example of the leakage inspection via the nozzle holes and the ejection channels C1e, C2e, C3e, C4e) shown in FIG. 11, and in particular in the example shown in FIG. 10, the following is brought about. That is, in the example shown in FIG. 10, since there is no need to perform suctioning on the whole (the ejection channels C1e, C2e, C3e, C4e) of the head chip 41 for performing the leakage inspection, the load on the head chip 41 decreases compared to the example shown in FIG. 11.

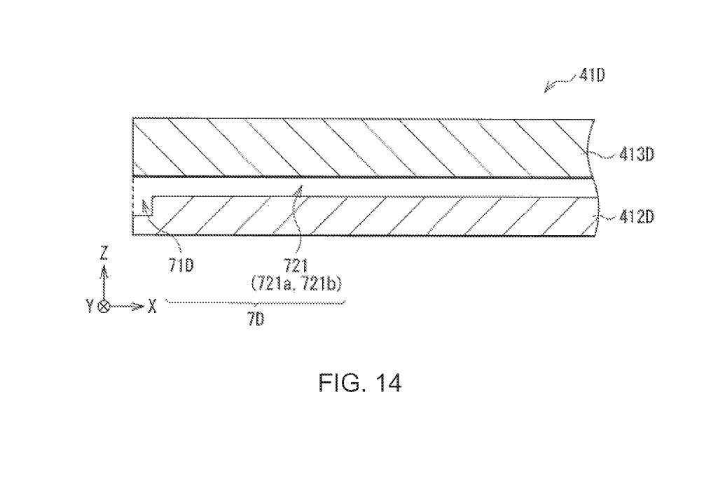

Further, as shown in FIG. 3 through FIG. 8, in the head chip 41 according to the present embodiment, the communication mechanism 7 has the opening part 71 described above, and communication channels (communication channels 721, 722) for communicating the opening part 71 and the dummy channels C1d, C2d, C3d and C4d with each other. Further, the opening part 71 is provided to the cover plate 413, and the communication channels 721, 722 are provided to both of the actuator plate 412 and the cover plate 413. In other words, as the communication channels described above, there are disposed the communication channels 721 provided to the actuator plate 412 and communicated with the dummy channels C1d, C2d, C3d and C4d, and the communication channel 722 provided to the cover plate 413 and communicating the opening part 71 and the communication channels 721 with each other. As described above, in the head chip 41, the dummy channels C1d, C2d, C3d, C4d and the outside of the head chip 41 are communicated with each other via the inside of the actuator plate 412 (the dummy channels C1d, C2d, C3d, C4d and the communication channels 721) and the cover plate 413 (the communication channel 722 and the opening part 71). Thus, the mechanical strength as the whole of the head chip 41 is enhanced compared to the case in which the communication mechanism is formed only in the actuator plate 412 as in the case of Modified Example 3 (see FIG. 14) described later, for example. Therefore, in the present embodiment, it becomes hard for breakage of the head chip 41 to occur compared to the case of such Modified Example 3 or the like, and it becomes possible to enhance the reliability of the head chip 41.

Further, in the head chip 41 according to the present embodiment, the communication channels (the communication channels 721, 722) in the communication mechanism 7 communicate all of the dummy channels C1d, C2d, C3d, C4d in the head chip 41 with the single opening part 71 (see FIG. 3 and FIG. 4). Thus, when detecting presence or absence of such a leakage state Led as described above (when performing the leakage detection), it is possible to perform the detection operation in a lump on all of the dummy channels C1d, C2d, C3d, C4d in the head chip 41. As a result, in the present embodiment, it is possible to realize the prompt leakage detection (which is applied to, for example, mass production and so on of the head chip 41), and it becomes possible to enhance the convenience.

In addition, in the head chip 41 according to the present embodiment, in the communication mechanism 7, the communication channels 721 (721a, 721b) provided to the actuator plate 412 extend along the arrangement direction (the X-axis direction) of the dummy channels C1d, C2d, C3d and C4d (see FIG. 3 through FIG. 8). Thus, it is possible to shorten the length (the length in the short-side direction of the head chip 41) of the head chip 41 in the perpendicular direction (the Y-axis direction) to the arrangement direction of the dummy channels C1d, C2d, C3d, C4d compared to the case in which, for example, the communication channels 721 extend along the direction (e.g., an oblique direction) crossing the arrangement direction described above. Specifically, in the case in which the plurality of nozzle columns is disposed along the longitudinal direction (the arrangement direction described above) of the head chip 41 as in the case of, for example, the present embodiment, since it becomes sufficient for the distance between the nozzles adjacent to each other to be short, it is also possible to shorten the length in the short-side direction of the head chip 41. Therefore, in the present embodiment, it becomes possible to make it difficult to be affected by a θ-shift (an angular shift with respect to the scan direction (the X-axis direction) of the recording paper P as the recording target medium) when attaching the head chip 41 in the printer 1 (the carriage 62) (see FIG. 1), when performing the recording operation by the printer 1, and so on.

Further, as shown in FIG. 3 and FIG. 4, in the head chip 41 according to the present embodiment, the opening part 71 in the communication mechanism 7 is formed in the end part area along the longitudinal direction (the X-axis direction) in the head chip 41. Thus, it becomes easy to suppress an increase in chip size in the head chip 41 (it is possible to reduce the length in the short-side direction of the head chip 41) compared to the case of forming the opening part 71 in, for example, the end part area along the short-side direction (the Y-axis direction) of the head chip 41. Therefore, in the present embodiment, it is possible to increase the number of the head chips 41 formed per unit area when manufacturing the head chips 41, and it becomes possible to decrease the manufacturing cost. Further, if the length in the short-side direction of the head chip 41 decreases, it is possible to reduce the size of the carriage 62 to which the head chip 41 is attached in the printer 1 (see FIG. 1). Therefore, in the present embodiment, since it is also possible to reduce the scanning distance (the reciprocation distance in the Y-axis direction) of the carriage 62 when performing the recording operation in the printer 1, it becomes possible to achieve miniaturization of the whole of the printer 1.

### 2. MODIFIED EXAMPLES

Then, some modified examples (Modified Examples 1 through 3) of the embodiment described above will be described. It should be noted that the same constituents as those in the embodiment are denoted by the same reference symbols, and the description thereof will arbitrarily be omitted.

### Modified Examples 1, 2

### (Configuration)

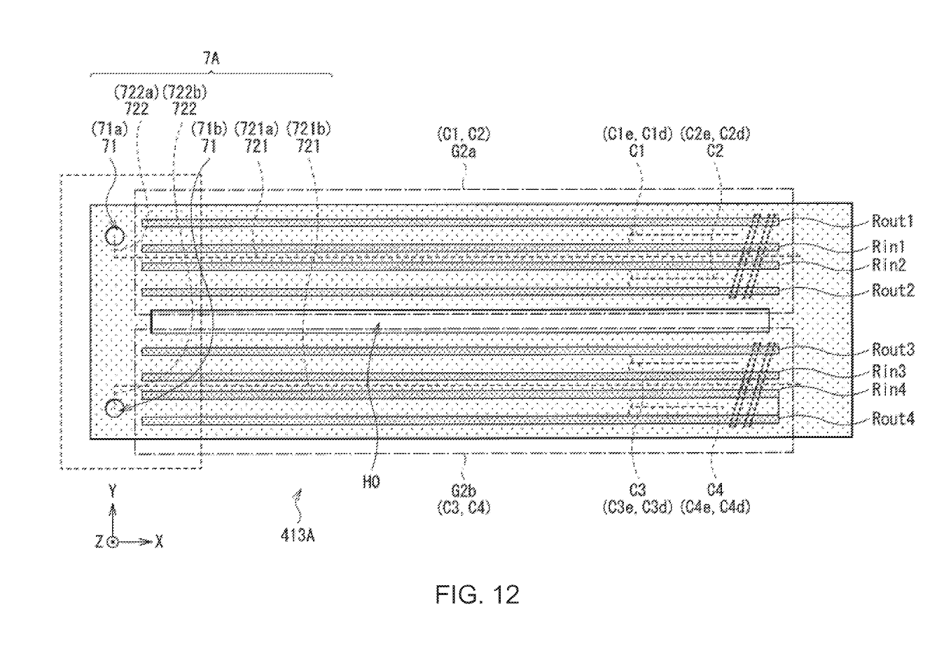

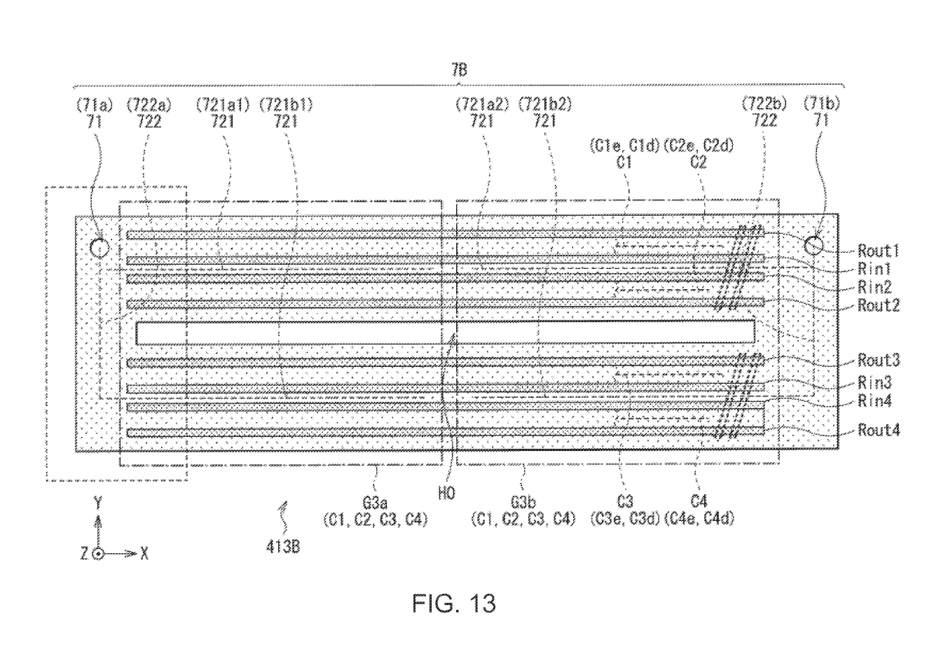

FIG. 12 is a diagram schematically showing a planar configuration example (an X-Y planar configuration example) of a cover plate 413A and so on in a head chip related to Modified Example 1. Further, FIG. 13 is a diagram schematically showing a planar configuration example (an X-Y planar configuration example) of a cover plate 413B and so on in a head chip related to Modified Example 2.

The head chip (a cover plate 413A) of Modified Example 1 corresponds to what is obtained by providing a communication mechanism 7A (FIG. 12) described hereinafter instead of the communication mechanism 7 in the head chip 41 (the cover plate 413) of the embodiment shown in FIG. 3, and the rest of the configuration is made basically the same. Further, the head chip (a cover plate 413B) of Modified Example 2 corresponds to what is obtained by providing a communication mechanism 7B (FIG. 13) described hereinafter instead of the communication mechanism 7 in the head chip 41 (the cover plate 413) of the embodiment shown in FIG. 3, and the rest of the configuration is made basically the same.

Specifically, in the communication mechanism 7 (FIG. 3) according to the embodiment, as described above, the communication channels 721, 722 in the communication mechanism 7 communicate all of the dummy channels C1d, C2d, C3d, C4d in the head chip 41 with the single opening part 71. In contrast, the communication channels 721, 722 in the communication mechanisms 7A, 7B (FIG. 12, FIG. 13) of the Modified Examples 1, 2 are arranged to communicate the opening part 71 and the dummy channels C1d, C2d, C3d, C4d with each other by a plurality of groups described hereinafter.

In detail, in the communication mechanism 7A of Modified Example 1 shown in FIG. 12, the dummy channels C1d, C2d, C3d, C4d in the head chip are sectioned into a plurality of groups (two groups G2a, G2b in this example). Specifically, it is arranged that the dummy channels C1d, C2d belong to the group G2a, and the dummy channels C3d, C4d belong to the group G2b. Further, the plurality of opening parts 71 are also formed (two opening parts 71a, 71b are formed in this example) so as to correspond to the plurality of groups G2a, G2b. It should be noted that in this example, both of the opening parts 71a, 71b are formed in one end part area along the longitudinal direction (the X-axis direction) in the head chip. Further, in the communication mechanism 7A of Modified Example 1, the communication channels 721 (721a, 721b), 722 (722a, 722b) individually communicate the opening part 71 and the dummy channels C1d, C2d, C3d, C4d with each other by the plurality of groups G2a, G2b. Specifically, the communication channels 721a, 722a communicate the opening part 71a and the dummy channels C1d, C2d belonging to the group G2a with each other. In contrast, the communication channels 721b, 722b communicate the opening part 71b and the dummy channels C3d, C4d belonging to the group G2b with each other.

Further, in the communication mechanism 7B of Modified Example 2 shown in FIG. 13, the dummy channels C1d, C2d, C3d, C4d in the head chip are sectioned into a plurality of groups (two groups G3a, G3b in this example). Specifically, a half (left half) of the channels along the X-axis direction in the dummy channels C1d, C2d, C3d, C4d belongs to the group G3a. In contrast, a half (right half) of the channels along the X-axis direction in the dummy channels C1d, C2d, C3d, C4d belongs to the group G3b. Further, the plurality of opening parts 71 are also formed (two opening parts 71a, 71b are formed in this example) so as to correspond to the plurality of groups G3a, G3b. It should be noted that in this example, the opening part 71a is formed in one end part area along the longitudinal direction (the X-axis direction) in the head chip, and the opening part 71b is formed in the other end part area along the longitudinal direction in the head chip. Further, in the communication mechanism 7B of Modified Example 2, the communication channels 721 (721a1, 721a2, 721b1, 721b2), 722 (722a, 722b) individually communicate the opening part 71 and the dummy channels C1d, C2d, C3d, C4d with each other by the plurality of groups G3a, G3b. Specifically, the communication channels 721a1, 721b1, 722a communicate the opening part 71a and the dummy channels C1d, C2d, C3d, C4d belonging to the group G3a with each other. In contrast, the communication channels 721a2, 721b2, 722b communicate the opening part 71b and the dummy channels C1d, C2d, C3d, C4d belonging to the group G3b with each other.

Here, the communication channels 721 (721a1, 721a2, 721b1, 721b2) each correspond to a specific example of a “first communication channel” in the present disclosure. Further, the communication channels 722 (722a, 722b) each correspond to a specific example of a “second communication channel” in the present disclosure.

### (Functions/Advantages)

In the head chips of Modified Examples 1, 2 having such configurations, it is also possible to obtain basically the same advantage due to the same function as that of the head chip 41 of the embodiment.

Further, in particular in Modified Examples 1, 2, as described above, the communication channels 721, 722 in the communication mechanisms 7A, 7B communicate the opening parts 71 and the dummy channels C1d, C2d, C3d, C4d with each other by a plurality of groups described above. Thus, it becomes possible to individually perform the detection operation for each of these groups when detecting presence or absence of such a leakage state Led as described above (when performing the leakage detection). As a result, it becomes easy to identify the generation place (the generation area) of the leakage state Led, and at the same time, the load on the head chip is reduced, and it becomes difficult for the breakage of the head chip to occur (which is applied to, for example, the case of trial production of the head chip or a reliability test of the head chip). Therefore, in Modified Examples 1, 2, it becomes possible to enhance the convenience and at the same time it becomes possible to enhance the reliability of the head chip compared to the embodiment.

It should be noted that in Modified Examples 1, 2, the description is presented citing the case in which the number of the groups is two (there are provided the two groups) as an example, but this example is not a limitation. In other words, the number of the groups which the dummy channels C1d, C2d, C3d, C4d are sectioned into can also be three or more such as three or four.

### Modified Example 3

FIG. 14 is a diagram schematically showing a cross-sectional configuration example (a Z-X cross-sectional configuration example) of a head chip (a head chip 41D) related to Modified Example 3. The head chip 41D of the present modified example corresponds to what is provided with a communication mechanism 7D described hereinafter instead of the communication mechanism 7 in the head chip 41 described in the embodiment, and the rest of the configuration is made basically the same. It should be noted that due to the change for providing such a communication mechanism 7D, in the present modified example, the actuator plate 412D and the cover plate 413D are provided instead of the actuator plate 412 and the cover plate 413 described in the embodiment.

Here, in the communication mechanism 7 (see FIG. 7, FIG. 8 and so on) of the embodiment, as described above, the opening part 71 is provided to the cover plate 413, and at the same time, the communication channels 721, 722 are provided to both of the actuator plate 412 and the cover plate 413. Specifically, in the head chip 41 according to the embodiment, the dummy channels C1d, C2d, C3d, C4d and the outside of the head chip 41 are communicated with each other via the inside of the actuator plate 412 (the dummy channels C1d, C2d, C3d, C4d and the communication channels 721) and the cover plate 413 (the communication channel 722 and the opening part 71).

In contrast, in the communication mechanism 7D of the present modified example shown in FIG. 14, both of the opening part 71D and the communication channels 721 (721a, 721b) are arranged to be formed inside the actuator plate 412D, but not to be formed inside the cover plate 413D. Specifically, the opening part 71D is formed on a side surface (a Y-Z side surface) of the actuator plate 412D, and is arranged to be exposed to the outside of the head chip. Further, the communication channels 721 (721a, 721b) communicate the opening part 71D and the dummy channels C1d, C2d, C3d, C4d with each other, and extend along the X-axis direction (the longitudinal direction of the head chip, the arrangement direction of the channels C1, C2, C3, C4). It should be noted that the opening part 71D is arranged to be sealed with an adhesive or the like after completing the leakage inspection.

In the head chip 41D of the present modified example having such a configuration, it is also possible to obtain basically the same advantage due to the same function as that of the head chip 41 of the embodiment.

Further, in particular in the communication mechanism 7D of the present modified example, since both of the opening part 71D and the communication channels 721 (721a, 721b) are formed inside the actuator plate 412D as described above, the following advantage, for example, can also be obtained. That is, it becomes possible to easily and simply form the communication mechanism 7A compared to the case of, for example, the communication mechanism 7 of the embodiment.

### 3. OTHER MODIFIED EXAMPLES

The present disclosure is described hereinabove citing the embodiment and some modified examples, but the present disclosure is not limited to the embodiment and so on, and a variety of modifications can be adopted.

For example, in the embodiment described above, the description is presented specifically citing the configuration examples (the shapes, the arrangements, the number and so on) of each of the members in the printer, the inkjet head and the head chip, but those described in the above embodiment and so on are not limitations, and it is possible to adopt other shapes, arrangements, numbers and so on. Further, the values or the ranges, the magnitude relation and so on of a variety of parameters described in the above embodiment and so on are not limited to those described in the above embodiment and so on, but can also be other values or ranges, other magnitude relation and so on.

Specifically, for example, in the embodiment described above, the description is presented citing the inkjet head 4 of the four column type (having the four nozzle columns), but the example is not a limitation. Specifically, for example, it is also possible to adopt an inkjet head of a single column type, a two column type, a three column type (having a single nozzle column, two nozzle columns, or three nozzle columns), or an inkjet head of a multi-column type with five or more columns (having five or more nozzle columns). Further, the “communication mechanism” in the present disclosure is not limited to the configuration example specifically described in the embodiment and so on described above, but can also be other configuration examples.

Further, for example, in the embodiment described above and so on, there is described the case in which the ejection channels (the ejection grooves) and the dummy channels (the non-ejection grooves) each extend along the oblique direction in the actuator plate 412, but this example is not a limitation. Specifically, it is also possible to arrange that, for example, the ejection channels and the dummy channels extend along the Y-axis direction in the actuator plate 412.

Further, for example, the cross-sectional shape of each of the nozzle holes (e.g., the nozzle holes H1, H2) is not limited to the circular shape as described in the above embodiment and so on, but can also be, for example, an elliptical shape, a polygonal shape such as a triangular shape, or a star shape.

In addition, in the embodiment and so on described above, the example of the so-called side-shoot type inkjet head for ejecting the ink 9 from the central part in the extending direction (the oblique direction described above) of the ejection channels C1e, C2e, C3e, C4e is described, but the example is not a limitation. Specifically, it is also possible to apply the present disclosure to a so-called edge-shoot type inkjet head for ejecting the ink 9 along the extending direction of the ejection channels C1e, C2e, C3e, C4e.

Further, in the embodiment described above, the description is presented citing the circulation type inkjet head for using the ink 9 while circulating the ink 9 mainly between the ink tank and the inkjet head as an example, but the example is not a limitation. Specifically, it is also possible to apply the present disclosure to a non-circulation type inkjet head using the ink 9 without circulating the ink 9.

Further, the series of processes described in the above embodiment and so on can be arranged to be performed by hardware (a circuit), or can also be arranged to be performed by software (a program). In the case of arranging that the series of processes is performed by the software, the software is constituted by a program group for making the computer perform the functions. The programs can be incorporated in advance in the computer described above, and are then used, or can also be installed in the computer described above from a network or a recording medium and are then used.

In addition, in the above embodiment, the description is presented citing the printer 1 (the inkjet printer) as a specific example of the “liquid jet recording device” in the present disclosure, but this example is not a limitation, and it is also possible to apply the present disclosure to other devices than the inkjet printer. In other words, it is also possible to arrange that the “head chip” and the “liquid jet head” (the inkjet heads) of the present disclosure are applied to other devices than the inkjet printer. Specifically, for example, it is also possible to arrange that the “head chip” and the “liquid jet head” of the present disclosure are applied to a device such as a facsimile or an on-demand printer.

In addition, it is also possible to apply the variety of examples described hereinabove in arbitrary combination.

It should be noted that the advantages described in the specification are illustrative only but are not a limitation, and another advantage can also be provided.

The present disclosure may be embodied as described below.

<1>

A head chip adapted to jet liquid comprising an actuator plate having a plurality of ejection grooves filled with the liquid, and a plurality of non-ejection grooves not filled with the liquid; a nozzle plate having a plurality of nozzle holes individually communicated with the plurality of ejection grooves while not being communicated with the plurality of non-ejection grooves; a cover plate having a plurality of through holes adapted to respectively fill the plurality of ejection grooves with the liquid, and adapted to close the plurality of non-ejection grooves; and a communication mechanism adapted to communicate an outside of the head chip and the plurality of non-ejection grooves with each other via an opening part exposed to the outside of the head chip.

<2>

The head chip according to <1>, wherein the communication mechanism includes the opening part, and a communication channel adapted to communicate the opening part and the non-ejection groove with each other.

<3>

The head chip according to <2>, wherein the opening part is provided to the cover plate, and the communication channel includes a first communication channel provided to the actuator plate, and communicated with the non-ejection groove, and a second communication channel provided to the cover plate, and adapted to communicate the opening part and the first communication channel with each other.

<4>

The head chip according to <2> or <3>, wherein the communication channel communicates all of the plurality of non-ejection grooves with the single opening part.

<5>

The head chip according to <2> or <3>, wherein the plurality of non-ejection grooves is sectioned into a plurality of groups, and the plurality of opening parts is formed so as to correspond respectively to the plurality of groups, and the communication channel individually communicates the opening parts and the non-ejection grooves with each other by the plurality of groups.

<6>

The head chip according to any one of <2> to <5>, wherein the plurality of non-ejection grooves is arranged side by side along a predetermined arrangement direction in a surface of the actuator plate, and the communication channel provided to the actuator plate extends along the arrangement direction of the plurality of non-ejection grooves.

<7>

The head chip according to any one of <1> to <6>, wherein the head chip has a longitudinal direction, and the opening part is formed in an end part area along the longitudinal direction in the head chip.

<8>

A liquid jet head comprising the head chip according to any one of <1> to <7>.

<9>

A liquid jet recording device comprising the liquid jet head according to <8>; and a containing section adapted to contain the liquid.

What is claimed is:

1. A head chip adapted to jet liquid comprising:
an actuator plate having a plurality of ejection grooves filled with the liquid, and a plurality of non-ejection grooves not filled with the liquid;
a nozzle plate having a plurality of nozzle holes individually communicated with the plurality of ejection grooves while not being communicated with the plurality of non-ejection grooves;
a cover plate having a plurality of through holes adapted to respectively fill the plurality of ejection grooves with the liquid, and adapted to close the plurality of non-ejection grooves; and
a communication mechanism adapted to communicate an outside of the head chip and the plurality of non-ejection grooves with each other via an opening part exposed to the outside of the head chip.

2. The head chip according to claim 1, wherein
the communication mechanism includes the opening part, and a communication channel adapted to communicate the opening part and the non-ejection groove with each other.

3. The head chip according to claim 2, wherein
the opening part is provided to the cover plate, and
the communication channel includes
a first communication channel provided to the actuator plate, and communicated with the non-ejection groove, and
a second communication channel provided to the cover plate, and adapted to communicate the opening part and the first communication channel with each other.

4. The head chip according to claim 2, wherein
the communication channel communicates all of the plurality of non-ejection grooves with the single opening part.

5. The head chip according to claim 2, wherein
the plurality of non-ejection grooves is sectioned into a plurality of groups, and the plurality of opening parts is formed so as to correspond respectively to the plurality of groups, and
the communication channel individually communicates the opening parts and the non-ejection grooves with each other by the plurality of groups.

6. The head chip according to claim 2, wherein
the plurality of non-ejection grooves is arranged side by side along a predetermined arrangement direction in a surface of the actuator plate, and
the communication channel provided to the actuator plate extends along the arrangement direction of the plurality of non-ejection grooves.

7. The head chip according to claim 1, wherein
the head chip has a longitudinal direction, and
the opening part is formed in an end part area along the longitudinal direction in the head chip.

8. A liquid jet head comprising:
the head chip according to claim 1.

9. A liquid jet recording device comprising:
the liquid jet head according to claim 8; and
a containing section adapted to contain the liquid.
